(19) United States
(12) Patent Application Publication
(10) Pub. No.: US 2017/0059414 A1
(43) Pub. Date: Mar. 2, 2017

(54) INFRARED DETECTOR AND TEMPERATURE SENSOR INCLUDING THE SAME

(71) Applicant: SAMSUNG ELECTRO-MECHANICS CO., LTD., Suwon-si (KR)

(72) Inventors: Sung Ho LEE, Suwon-si (KR); Sang Yong YU, Suwon-si (KR); Jae Youn JEONG, Suwon-si (KR); Yeong Il KIM, Suwon-si (KR)

(73) Assignee: SAMSUNG ELECTRO-MECHANICS CO., LTD., Suwon-si (KR)

(21) Appl. No.: 15/073,866

(22) Filed: Mar. 18, 2016

(30) Foreign Application Priority Data
Aug. 25, 2015 (KR) 10-2015-0119753

(51) Int. Cl. G01J 5/08; G01K 7/02

(52) U.S. Cl. CPC G01J 5/08; G01K 7/02

(57) ABSTRACT

An infrared detector includes thermocouples configured to generate electromotive force upon receiving thermal energy and an absorber configured to absorb infrared light and disposed on a surface of each of the thermocouples. The thermocouples are arranged radially and the absorber is provided at first ends of respective thermocouples, the first end configured to be a hot junction.

### CROSS-REFERENCE TO RELATED APPLICATION

This application claims the benefit under 35 USC 119(a) of Korean Patent Application No. 10-2015-0119753 filed on Aug. 25, 2015, in the Korean Intellectual Property Office, the disclosure of which is incorporated herein by reference for all purposes.

### BACKGROUND

1. Field

The following description relates to a thermopile-type infrared detector and a temperature sensor including the same.

2. Description of Related Art

Sensors for measuring a temperature may be classified as contact-type temperature sensors or non-contact-type temperature sensors. Contact-type temperature sensors measure temperature in a state in which a measurement target and the sensor are thermally balanced, while non-contact temperature sensors measure temperature by sensing light or heat emitted from a measurement target, without being in direct contact with the target. Temperature can be measured using a non-contact temperature sensor because a relationship exists between temperature, light, and thermal energy.

Thus, non-contact-type temperature sensors may measure temperatures once a target that is to have its temperature measured becomes visible, including a moving target.

To date, contact-type temperature sensors have been commonly used. However, since demand for products monitoring the temperatures of high-temperature and moving objects has increased, demand for non-contact-type temperature sensors has also increased.

Among non-contact-type temperature sensors, existing thermopile-type temperature sensors generally have a quadrangular structure. Thermopile-type sensors are commonly disposed on boards and typically have thin quadrangular shapes that fill spaces in portions of the board.

In order to adsorb infrared light effectively, an absorber for absorbing infrared light is typically formed entirely on one surface of the thermopile.

However, when the absorber is formed on the entirety of the one surface of the thermopile, the size of a mass for holding heat (e.g. the absorber) may also increase, which may slow response speeds.

Existing thermopile-type temperature sensors typically sense temperatures using a thermoelectric effect in a plurality of thermocouples connected in series. Thus, as the number of integrated thermocouples is increased, the sensitivity of the temperature sensor may be increased.

However, when the thermocouples are disposed in an integrated manner, an area of the absorber may likewise increase. This may compound the problem of degradation in response speeds due to an increase in a mass of the absorber, as mentioned above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, and infrared detector includes thermocouples configured to generate electromotive force upon receiving thermal energy and an absorber configured to absorb infrared light and disposed on a surface of each of the thermocouples. The thermocouples are arranged radially and the absorber is provided at first ends of respective thermocouples, the first end configured to be a hot junction.

The absorber may have an annular shape connecting respective first ends of the thermocouples.

The thermocouples may include groups of thermocouples, each group having the same length. The absorber may be formed to have an annular shape in each of groups of thermocouples having the same length.

The thermocouples may include thermocouples having a shorter length disposed between neighboring thermocouples having the same length.

Respective absorbers may be provided in each of the thermocouples, each respective absorber spaced apart from adjacent absorbers.

Each of the respective absorbers may extend outwardly from the first end of each of the thermocouples.

The absorber may include at least one material selected from the group including Au-black, silicon (Si), SiO2, and a carbon series.

Respective absorbers may be deposited or pasted on the first end of each of thermocouples.

In another general aspect, a temperature sensor includes an infrared detector including thermocouples configured to generate electromotive force upon receiving thermal energy and an absorber configured to absorb infrared light and disposed on a surface of each of the thermocouples, and a board to which the infrared detector is coupled. The thermocouples are arranged radially and the absorber is provided at first ends of respective thermocouples, the first end configured to be a hot junction.

The board may include an electric pad connecting the thermocouples.

The board may include a reflector provided on each thermocouple, and disposed at a second end of each of the thermocouples, the second end configured to be a cold junction.

The board may include a heat sink connected to the reflector to dissipate heat.

The heat sink may be formed integrally to the reflector, and may include the same material as the reflector.

The reflector may include least one material selected from the group including gold (Au), silver (Ag), or aluminum (Al).

The board may include an annular-shaped reflector provided on each thermocouple, and disposed at second ends of each of the thermocouples, the second end configured to be a cold junction.

The board may include a support layer configured to support the thermocouples.

The support layer may include an upper layer and a lower layer, the upper layer including a material having low thermal conductivity.

### BRIEF DESCRIPTION OF DRAWINGS

FIG. 1 is a plan view illustrating an example of an infrared detector including an annular-shaped absorber.

FIG. 2 is a plan view illustrating an example of an infrared detector including an absorber individually provided in respective thermocouples.

FIG. 3 illustrates an example of a temperature sensor including an annular-shaped absorber.

FIG. 4 illustrates an example of a temperature sensor including an absorber individually provided in respective thermocouples.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

Expressions such as “first conductivity type” and “second conductivity type” as used herein may refer to opposite conductivity types such as N and P conductivity types, and examples described herein using such expressions encompass complementary examples as well. For example, an example in which a first conductivity type is N and a second conductivity type is P encompasses an example in which the first conductivity type is P and the second conductivity type is N.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views illustrating these embodiments. In the drawings, for example, due to manufacturing techniques and/or tolerances, modifications of the shape shown may be estimated. Thus, embodiments should not be construed as being limited to the particular shapes of regions shown herein, for example, to include a change in shape results in manufacturing. The following embodiments may also be constituted by one or a combination thereof.

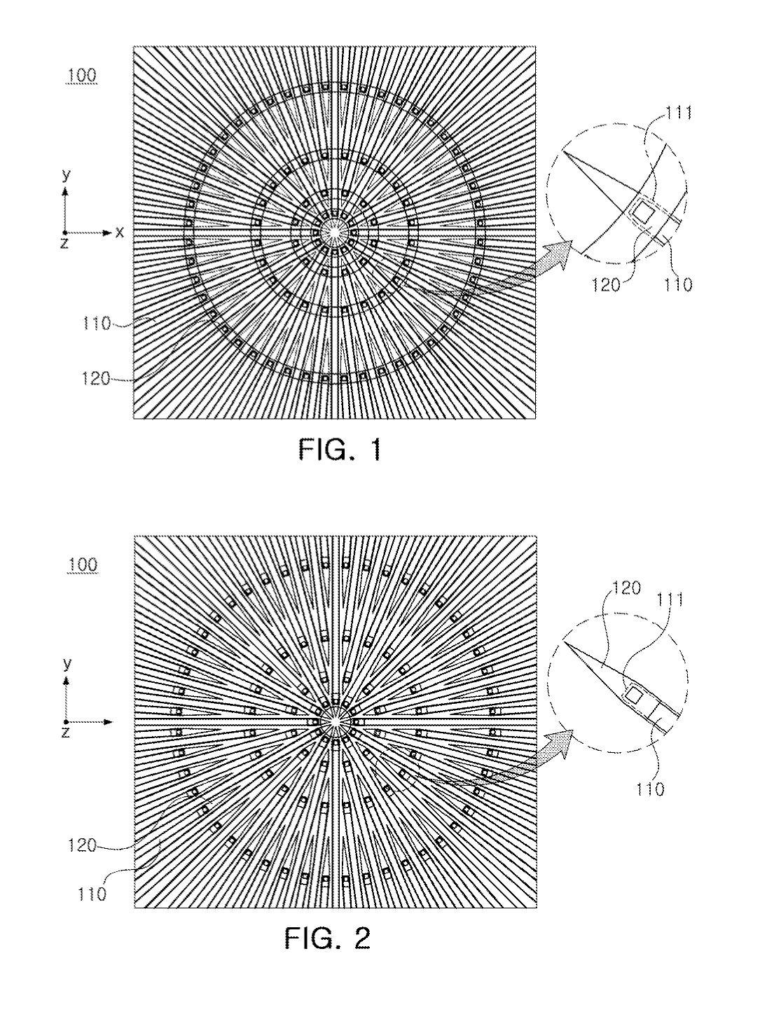

FIG. 1 is a plan view illustrating an example of an infrared detector 100 in which an absorber 120 has an annular shape. Referring to FIG. 1, the infrared detector 100 includes thermocouples 110 configured to generate electromotive force upon receiving thermal energy and absorbers 120 respectively provided on corresponding surfaces of the thermocouples 110. Infrared light may radiate onto absorbers 120 and absorbers 120 may absorb the infrared light. Thermocouples 110 may be disposed radially, and the absorbers 120 may be provided at respective ends of each of the thermocouples 110. The absorbers 120 have an annular shape connecting the respective ends of the thermocouples 110.

Each of the absorbers 120 may have low mass, while increasing a temperature of a hot junction 111. That is, hot junction 111 may be an end having a higher temperature, among both ends of the thermocouples 110, due to a concentrated absorption of infrared light. Thus, a response speed may be increased.

The absorbers 120 are disposed on the hot junctions 111 as ends of the radially-disposed thermocouples 110 so the absorbers 120 may concentrate heat on the hot junctions 111, while reducing mass.

Thus, a temperature sensor using the infrared detector 100 may have increased sensitivity and increased response speed.

Although embodiments showing a temperature sensor are described, uses of the infrared detector 100 are not limited thereto. For example, infrared detector 100 may be applied to any field which uses thermal energy generated through absorption of infrared light.

As described, the case in which a wavelength band to be detected is in the infrared wavelength range is described, but embodiments are not limited thereto. For example, infrared detector 100 may be applied to a field in which terahertz waves are to be detected.

The thermocouples 110 may generate electromotive force according to a difference in temperature between both ends thereof. When a temperature differential occurs due to heat collection by the absorber 120, electromotive force is generated.

To this end, the thermocouples 110 may have a first member and a second member formed of heterogeneous materials. For example, when the first member is formed of an n-type thermoelectric semiconductor, the second member may be formed of a p-type thermoelectric semiconductor.

Here, the n-type and p-type thermoelectric semiconductors may be used by appropriately doping a material, for example, a thermoelectric material such as a BiTe-based material or a PbTe-based material.

When the first member is formed of a semiconductor such as graphene, the second member may be formed of a metal. Graphene is a material obtained by delaminating a surface layer of graphite and is a nanomaterial formed of carbon. Also, graphene is a semiconductor having a two-dimensional (2D) planar shape, room-temperature carrier mobility, high thermal conductivity, and excellent electrical conductivity.

The first member and the second member of each of the thermocouples 110 may be formed of heterogeneous metals, and thus, electromotive force may be generated between the first member and the second member on the basis of a change in temperature. However, any other material may also be applied as long as it is able to generate electromotive force on the basis of a change in temperature.

The first member and the second member may be coupled to form the hot junction 111 and a cold junction 112 at ends thereof, and electromotive force may be generated based on a difference in temperature between the hot junction 111 and the cold junction 112.

That is, when a temperature differential is generated between the hot junction 111 and the cold junction 112 of the first member or the second member constituting the thermocouples 110, a voltage difference is made at both ends of the first member or the second member due to a Seebeck effect. As a result, a temperature is detected on the basis of the generated voltage, and thermocouples 110 can be used as the basis for a temperature sensor as described hereinafter.

In particular, in order for a temperature sensor to be sensitive, electromotive force output according to a change in temperature between the hot junction 111 and the cold junction 112 needs to be relatively high. To this end, the absorbers 120 are provided to the hot junctions 111 as the ends of the thermocouples 110.

A principle of generating electromotive force by the thermocouples 110 will be described. A terminal voltage V_{g} that may be induced by a closed circuit of the thermocouples 110 (members) through the Seebeck effect results from a difference between a thermal input qₐ and a discharge amount of heat q_{d}. Here, the thermal input and the discharge amount of heat may be obtained as expressed by Equation 1 and Equation 2.

qₐ=αₑTₕⱼI−½rₑI²+KₑΔTⱼ [Equation 1]

q_{d}=αₑT_{cj}I+½rₑI²+KₑΔTⱼ [Equation 2]

In the above equations, αₑ denotes a Seebeck coefficient, Tₕⱼ denotes a temperature on a high temperature side, T_{cj} denotes a temperature on a low temperature side, I denotes applied current, rₑ denotes a resistance of a member, Kₑ denotes a thermal conductivity of a member, and ΔTⱼ denotes a temperature differential.

The first term of Equation 1 and Equation 2 is a thermal pumping effect by a thermoelectric element. Thus, the thermal pumping effect is dependent upon the Seebeck coefficient of the thermoelectric element and the applied current.

In Equation 1 and Equation 2, the second terms are losses due to Joule heating. Heat may be generated in the same material, but a larger amount of heat is generated from a contact between heterogeneous materials. In particular, the second terms are proportional to the square of a current.

Finally, the third items of Equation 1 and Equation 2 are based on thermal equilibrium related to a heat sink 230.

As a result, a difference between Equation 1 and Equation 2 is calculated as an output of electric energy P_{g} as expressed by Equation 3 below.

P_{g}=qₐ−q_{d}=(αₑΔTⱼ−rₑI)I [Equation 3]

The terminal voltage V_{g} of the closed circuit may be from Equation 3 and the power formula P=VI, as shown in Equation 4 below.

V_{g}=αₑΔTⱼ−rₑI [Equation 4]

Thus, it can be seen that, in order to increase sensitivity of the temperature sensor, the electromotive force of the thermocouples 110 needs to be increased. To this end, a temperature differential between both ends of each of the thermocouples 110 may be increased by using the as expressed by Equation 4.

Additionally or alternatively, increase of the electromotive force may also be achieved by increasing a total terminal voltage by increasing the number of thermocouples 110 per unit area of a predetermined board 200.

In order to increase the temperature differential between the ends of the thermocouples 110 and integrate a larger amount of the thermocouples 110 per unit area of the board 200, exemplary shape and arrangements of thermocouples 110 and absorbers 120 are shown in FIGS. 1-4. However, other arrangements which also increase the temperature differential between the ends of the thermocouples 110 and integrate a larger amount of the thermocouples 110 per unit area of the board 200 are possible.

The absorbers 120 may absorb infrared light to increase a temperature at the hot junctions 111. To this end, the absorbers 120 may be provided at one end of the radially-arranged thermocouples 110. Here, since the absorbers 120 are provided in a radial manner to allow the hot junctions 111 to be disposed near one another, the area covered by the absorbers 120 may be reduced.

Accordingly, when the thermocouples 110 and the absorbers 120 are not configured in the manner as described above, the area of the absorbers 120 may be increased, which also may increase the overall mass of the absorbers 120. In this comparative example, in order to increase a temperature of the absorbers 120, the amount of infrared light to be absorbed by the absorbers 120 needs to be increased, making it difficult to quickly increase a temperature of the hot junctions 111 of the thermocouples 110. As a result, a response speed of a temperature sensor in which the infrared detector 100 is installed is lowered.

In order to prevent this, according to an embodiment, a formation area of the absorbers 120 is reduced. Accordingly, mass of the absorbers 120 is also reduced thereby increasing a response speed of the temperature sensor.

Each of the absorbers 120 may be respectively provided on each of the thermocouples 110. Details thereof will be described hereinafter with reference to FIG. 2.

The absorbers 120 may be provided in an annular shape on the hot junctions 111 of the thermocouples 110. Here, since the thermocouples 110 are arranged radially, the absorbers 120 may also be formed to have an annular shape.

As shown in FIG. 2, in order to increase sensitivity of the temperature sensor by integrating a larger amount of thermocouples 110 per unit area, shorter thermocouples 110 may be provided between neighboring thermocouples 110 having the same length.

In accordance with the disposition of the thermocouples 110, the absorbers 120 may also have an annular shape in each thermocouple 110 group having the same length.

That is, in an embodiment, the thermocouples 110 of the infrared detector 100 are formed in groups having the same length, and the absorbers 120 are formed to have an annular shape corresponding to each of the groups of the thermocouples 110 having the same length.

Also, in the infrared detector 100 according to the exemplary embodiment, the shorter thermocouples 110 are provided between neighboring thermocouples 110 having the same length.

In this manner, the absorbers 120 contact the hot junctions 111 of the thermocouples 110 and may absorb infrared light and transmit generated thermal energy toward the hot junctions 111 of the thermocouples 110.

The absorbers 120 may contain at least one of Au-black, Si, SiO2, and carbon, but the material of the absorbers 120 is not limited thereto.

The absorbers 120 may be formed by depositing (e.g. by pasting) an infrared absorption material on the hot junctions 111 of the thermocouples 110.

That is, in the infrared detector 100 according to an embodiment, the absorbers 12 may contain at least one material of Au-black, Si, SiO2, and carbon groups.

In the infrared detector 100 according to an embodiment, the absorbers 120 may be formed on ends of the thermocouples 110 through, for example, deposition or pasting, however, embodiments are not limited thereto.

FIG. 2 is a plan view illustrating the infrared detector 100 in which the absorber 120 is individually provided in each of the thermocouples 110. Referring to FIG. 2, in the infrared detector 100 according to an embodiment, the absorbers 120 are respectively provided on each of the thermocouples 110 and spaced apart from neighboring thermocouples 110. In the infrared detector 100 according to an embodiment, the absorbers 120 are provided in each of the plurality of thermocouples 110, and spaced apart from the neighboring thermocouples 110.

The shape of the absorbers 120 is such that a formation area of the absorbers 120 may be reduced, while electromotive force generated by the thermocouples 110 may be increased. This effect may occur because a rate of absorption of infrared light by the absorbers 120 is increased, thereby increasing electromotive force generated by the thermocouples 110. Because the formation area of absorbers 120 may be reduced, a mass of the absorbers 120 to increase a response speed of the temperature sensor.

In other words, each absorber 120 may be individually formed on each of the plurality of thermocouples 110, additionally or alternatively to being formed in the aforementioned annular shape.

The absorbers 120 of the infrared detector 100 according to an embodiment extend outwardly from one end of each of the thermocouples 110.

That is, in order to increase generation of electromotive force by the thermocouples 110 by absorbing more infrared light, the absorbers 120 may have a shape that extends outwardly from one end of each of the thermocouples 110.

Thus, a temperature sensor using the infrared detector 100 described above may have increased sensitivity and a faster response speed as compared to a comparative embodiment.

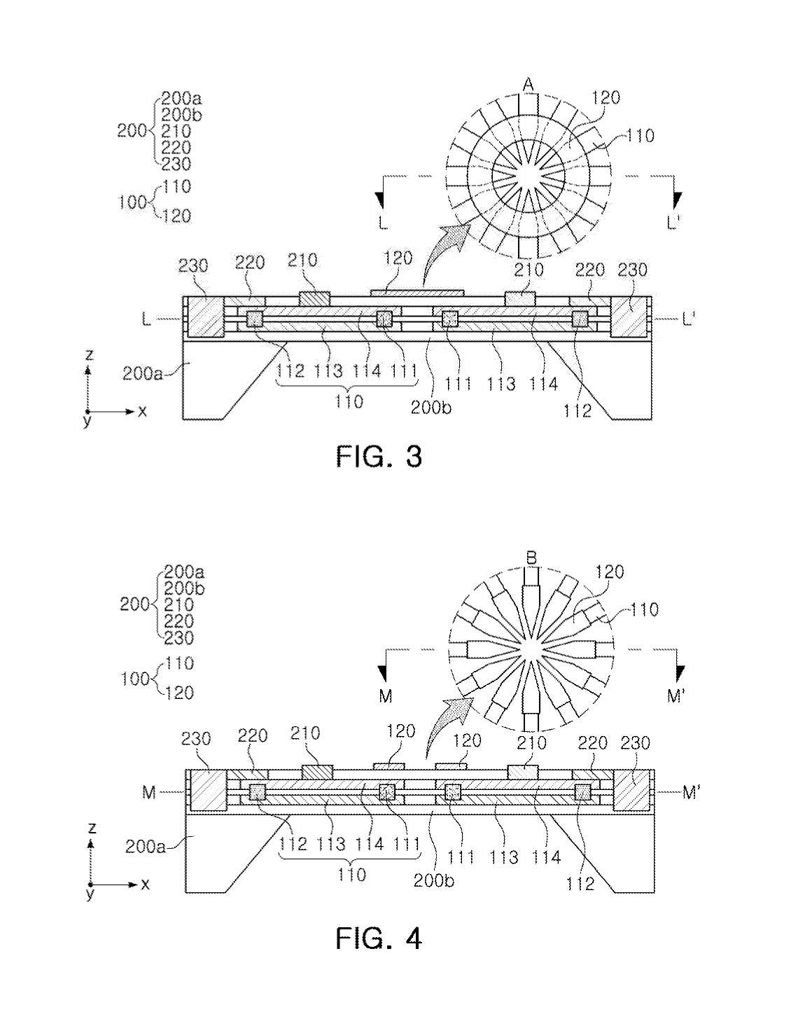

FIG. 3 illustrates a temperature sensor having annular-shaped absorbers 120 according to an embodiment. FIG. 4 illustrates a temperature sensor in which the absorber 120 is individually provided on respective thermocouples 110.

Referring to FIGS. 3 and 4, a temperature sensor may include the infrared detector 100 and a board 200 to which the infrared detector 100 is coupled.

The board 200 of the temperature sensor according to another exemplary embodiment may include an electric pad 210 configured to connect thermocouples 110.

The board 200 of the temperature sensor according to an embodiment may include a reflector 220 provided on a surface of each of the thermocouples 110 on which infrared light is configured to be irradiated. The reflector 220 is disposed on a cold junction 112 of the thermocouple 110.

The board 200 of the temperature sensor according to an exemplary embodiment may include a heat sink 230 connected to the reflector 220 and configured to dissipate heat.

A temperature sensor may include the infrared detector 100. The temperature sensor, including the board 200 and infrared detector 100, is configured to sense a temperature of a target using electromotive force generated by the infrared detector 100 in a non-contact manner.

The board 200 may include a first support layer 200a and a second support layer 200b forming a body, and further includes the electric pad 210, the reflector 220, and the heat sink 230.

The board 200 may be integrally formed of a material such as silicon, or the like, but the material of the board 200 is not limited thereto and the board 200 may include various materials.

The second support layer 200b is provided on the first support layer 200a. The first support layer 200a may include silicon, etc. In this manner, the second support layer 200b may cover the first support layer 200a to support the thermocouples 100.

The second support layer 200b may include a material having low thermal conductivity. When the second support layer 200b is formed of a material having low thermal conductivity, thermal resistance between the hot junction 111 and the cold junction 112 of the thermocouple 110 may be increased. The second support layer 200b may include a silicon nitride, but a material of the second support layer 200b is not limited thereto.

The electric pad 210 for outputting electromotive force generated by the plurality of thermocouples 110 may be provided to connect the plurality of thermocouples on the board 200.

In order to increase sensitivity, the temperature sensor according to an embodiment may further include the reflector 220. By using reflector 220, a temperature differential between the hot junction 111 and the cold junction 112 of the thermocouple 110 can be increased.

The absorber 120 is disposed on the hot junction 111 of the thermocouple 110 to increase a temperature of the hot junction 111, while the reflector 220 lowers a temperature of the cold junction 112 of the thermocouple 110.

To this end, the reflector 220 is provided on the cold junction 112, on the opposite end portion of the thermocouple 110 as the hot junction 111, and provided on a surface of the thermocouple 110 on which infrared light is irradiated.

The reflector 220 may reflect incident infrared light, creating the cold junction 112 positioned at corresponding junction of the thermocouple 110.

The reflector 220 may include a material having high reflectivity of infrared light, for example, a metal such as gold (Au), silver (Ag), or aluminum (Al). However, the material of the reflector 220 is not limited thereto.

The reflector 220 may have a thickness sufficient for preventing infrared light from being transmitted therethrough, and may be formed by depositing (e.g. pasting) an infrared reflecting material on the cold junction 112 of the thermocouple 110.

Thus, the reflector 220 may be provided in an annular shape at the respective ends of the thermocouples 110 at with the cold junctions 112 are disposed. Alternatively, the reflector 220 may be individually provided at the other ends of the plurality of thermocouples 110.

Thus, the reflector 220 may increase reflection of light in the infrared spectrum, preventing transmission of thermal energy to the cold junction 112, and thus, the cold junction 112 may maintain a high temperature differential from the hot junction 111.

As mentioned above, the case in which a wavelength band to be detected is in the infrared wavelength range is described, but embodiments are not limited thereto. For example, infrared detector 100 may be applied to a field in which terahertz waves are to be detected.

The heat sink 230 may be formed of copper (Cu) or aluminum (Al) and, as shown in FIGS. 3 and 4, may be connected to the reflector 220.

Additionally or alternatively, extension portions may be formed at both ends of the reflector 220 to play the role of the heat sink 230. These extension portions may be formed integrally to reflector 220 and may include the same material as reflector 220. However, embodiments are not limited thereto. For example, the extension portions may be formed of a different material as reflector 220.

In this manner, in the temperature sensor according to an exemplary embodiment, an infrared ray absorption rate may be increased by using the absorber 120 in the hot junction 111 of the thermocouple 110 to increase a temperature thereof, and the infrared ray absorption rate is lowered by the reflector 220 in the cold junction 112 to cool the cold junction 112 and by the heat sink 230 to lower a temperature thereof, whereby sensitivity may be increased.

That is, in the temperature sensor according to an embodiment, electromotive force is generated according to a temperature differential between the hot junction 111 and the cold junction 112 when infrared light is irradiated onto the temperature sensor. Infrared light is thereby detected on the basis of the changed electromotive force.

Sensitivity may be increased by increasing the output electromotive force by increasing a temperature differential between the hot junction 111 and the cold junction 112.

Embodiments relate to the thermopile-type infrared detector 100 and the temperature sensor including the same, in which a temperature differential made between the hot junction 111 and the cold junction 112, disposed on opposite ends of the thermocouple 110, may be increased, while reducing mass of the infrared absorber 120.

Thus, since the temperature differential between both ends of the thermocouple 110 is increased, increased electromotive force, compared with a comparative example, may be output to increase sensitivity.

Since the mass of the infrared absorber 120 is reduced, an influence of a thermal inflow based on infrared light may be rapidly transmitted to increase a response speed.

As set forth above, the infrared detector and the temperature sensor including the same according to embodiments may output an increased electromotive force, compared with a comparative example, by increasing a temperature differential between the hot junction and the cold disposed on respective ends of the thermocouple, while reducing mass of the infrared absorber, obtaining an effect of increasing sensitivity.

Since the mass of the infrared absorber is reduced, an influence of a thermal inflow based on infrared light may be rapidly transmitted to increase a response speed.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An infrared detector, comprising:
thermocouples to generate electromotive force upon receiving thermal energy; and
an absorber, configured to absorb infrared light, disposed on a surface of each of the thermocouples,
wherein the thermocouples are disposed adjacent to one another and the absorber is provided at first ends of respective thermocouples.

2. The infrared detector of claim 1, wherein the absorber has an annular shape connecting respective first ends of the thermocouples.

3. The infrared detector of claim 1, wherein:
the thermocouples comprise groups of thermocouples, each group having the same length; and
the absorber has an annular shape in each of the groups of thermocouples having the same length.

4. The infrared detector of claim 3, wherein the thermocouples comprise thermocouples having a shorter length disposed between neighboring thermocouples having the same length.

5. The infrared detector of claim 1, wherein respective absorbers are disposed on each of the thermocouples, each respective absorber spaced apart from adjacent absorbers.

6. The infrared detector of claim 5, wherein each of the respective absorbers extends outwardly from the first end of each of the thermocouples.

7. The infrared detector of claim 1, wherein the absorber comprises at least one material selected from the group consisting of Au-black, silicon (Si), SiO2, and a carbon series.

8. The infrared detector of claim 1, wherein respective absorbers are deposited or pasted on the first end of each of thermocouples.

9. A temperature sensor, comprising:
an infrared detector, comprising:
thermocouples to generate electromotive force upon receiving thermal energy; and
an absorber configured to absorb infrared light and disposed on a surface of each of the thermocouples; and
a board to which the infrared detector is coupled,
wherein the thermocouples are arranged adjacent to each other and the absorber is disposed at first ends of respective thermocouples.

10. The temperature sensor of claim 9, wherein the board comprises an electric pad connecting the thermocouples.

11. The temperature sensor of claim 9, wherein the board comprises a reflector disposed on each thermocouple, and disposed at a second end of each of the thermocouples.

12. The temperature sensor of claim 11, wherein the board comprises a heat sink connected to the reflector.

13. The temperature sensor of claim 12, wherein the heat sink is integral to the reflector, and comprises the same material as the reflector.

14. The temperature sensor of claim 9, wherein the reflector comprises least one material selected from the group consisting of gold (Au), silver (Ag), or aluminum (Al).

15. The temperature sensor of claim 9, wherein the board comprises an annular-shaped reflector disposed on each thermocouple, and disposed at second ends of each of the thermocouples.

16. The temperature sensor of claim 9, wherein the board comprises a support layer configured to support the thermocouples.

17. The temperature sensor of claim 16, wherein the support layer comprises an upper layer and a lower layer, the upper layer comprising a material having low thermal conductivity.

18. The temperature sensor of claim 1, wherein the first ends of respective thermocouples comprise hot junctions.

19. The temperature sensor of claim 9, wherein the thermocouples are arranged radially.
